(19) United States
(12) Patent Application Publication
(10) Pub. No.: US 2012/0140662 A1
(43) Pub. Date: Jun. 7, 2012

(54) METHOD AND APPARATUS FOR DETERMINING LENGTH OF TRANSMISSION FRAME BASED ON LINK QUALITY INDICATOR (LQI)

(75) Inventors: Hoon JEONG, Daejeon (KR); Gwan Joong KIM, Daejeon (KR); Nae Soo KIM, Daejeon (KR)

(73) Assignee: Electronics and Telecommunications Research Institute, Daejeon (KR)

(21) Appl. No.: 13/312,411

(22) Filed: Dec. 6, 2011

(30) Foreign Application Priority Data
Dec. 6, 2010 (KR) 10-2010-0123796

(51) Int. Cl. H04L 12/26

(52) U.S. Cl. 370/252

(57) ABSTRACT

A method and apparatus for determining a length of a transmission frame based on a Link Quality Indicator (LQI) are provided. A target transmitter may request an LQI from a target receiver, and the target receiver may transmit information about the LQI to the target transmitter. The target transmitter may determine the length of the transmission frame based on the LQI. The target transmitter) may determine the length of the transmission frame proportional to the LQI.

### CROSS-REFERENCE TO RELATED APPLICATION

This application claims the benefit of Korean Patent Application No. 10-2010-0123796, filed on Dec. 6, 2010, in the Korean Intellectual Property Office, the disclosure of which is incorporated herein by reference.

### BACKGROUND

1. Field of the Invention

The present invention relates to a method and apparatus for determining a length of a transmission frame based on a Link Quality Indicator (LQI).

2. Description of the Related Art

Generally, a wireless communication system performs various channel coding schemes in order to reduce an error occurring during a transmission process.

However, according to IEEE 802.15.4 standards, data is wirelessly transmitted without performing channel coding, for miniaturization and low power consumption of a device. Accordingly, when a single error occurs during a wireless transmission process, a packet may be discarded. Hence, when a transmitter wirelessly transmits data according to IEEE 802.15.4 standards, and fails to receive an acknowledgement of the transmitted data from a receiver, the transmitter may recognize the transmitted data as having failed to be transferred under ordinary conditions, and may continuously retransmit the data within a predetermined maximum number of times for retransmission until an acknowledgement is received.

As aforementioned, the transmitter may secure a reliability of data transfer by retransmitting a corresponding packet with respect to the error occurring during the wireless transmission process, however, power consumption and data transmission time may increase due to the retransmission. Also, since the channel coding is not performed, a length of data may increase, and accordingly a frequency of errors occurring may also increase.

### SUMMARY

An aspect of the present invention provides a method and apparatus for determining a length of a transmission frame based on a Link Quality Indicator (LQI) in order to improve a reliability of data transmission.

In particular, the length determination method of the transmission frame may be applied to a local area wireless communication system compliant with IEEE 802.15.4 standards.

According to an aspect of the present invention, there is provided a communication method of a target transmitter, the method including transmitting, to a target transmitter, an LQI request message for requesting an LQI for a link from the target transmitter to a target receiver, receiving, from the target receiver, an LQI response message including information about the LQI, determining a length of a transmission frame including data for the target receiver, based on the LQI, and transmitting the data for the target receiver using the transmission frame of which length may be determined.

The determining may include determining the length of the transmission frame proportional to the LQI.

The method may further include generating a header of the transmission frame, including information about the length of the transmission frame.

The target transmitter may correspond to a transmitter of a local area wireless communication system compliant with IEEE 802.15.4 standards.

The LQI request message may include a pilot signal that may be a basis for measuring of the LQI by the target receiver.

The method may further include measuring an LQI for a link from the target receiver to the target transmitter, based on the LQI response message received from the target receiver, and the determining may include determining the length of the transmission frame including the data for the target receiver based on the LQI, and the LQI for the link from the target receiver to the target transmitter.

According to another aspect of the present invention, there is provided a communication method of a target receiver corresponding to a target transmitter, the method including receiving an LQI request message for requesting an LQI for a link from a target transmitter to a target receiver, measuring the LQI based on the LQI request message, transmitting, to the target transmitter, an LQI response message including information about the LQI, and receiving data for the target receiver from the target transmitter, using a transmission frame of which length may be determined based on the LQI.

The receiving may include acquiring information about the length of the transmission frame by decoding a header of the transmission frame, and acquiring data for the target receiver by decoding a region including the data for the target receiver based on the acquired information about the length of the transmission frame.

The target receiver may correspond to a receiver of a local area wireless communication system compliant with IEEE 802.15.4 standards.

The LQI response message may include a pilot signal that may be a basis for measuring of an LQI from the target receiver to the target transmitter by the target transmitter.

According to still another aspect of the present invention, there is provided a target transmitter including an LQI request message generation unit to generate an LQI request message for requesting an LQI for a link from a target transmitter to a target receiver, a transmission unit to transmit the generated LQI request message to the target receiver, a reception unit to receive, from the target receiver, an LQI response message including information about the LQI, and a transmission frame length determination unit to determine a length of a transmission frame including data for the target receiver, proportional to the LQI, and the transmission unit may transmit the data for the target receiver using the transmission frame of which length may be determined.

The target transmitter may further include a transmission frame generation unit to generate a header of the transmission frame including information about the length of the transmission frame.

The target transmitter may correspond to a transmitter of a local area wireless communication system compliant with IEEE 802.15.4 standards.

The LQI request message generation unit may generate the LQI request message including a pilot signal that may be a basis for measuring of the LQI by the target receiver.

The target transmitter may further include an LQI measurement unit to measure an LQI for a link from the target receiver to the target transmitter, based on the LQI response message received from the target receiver, and the transmission frame length determination unit may determine the length of the transmission frame including the data for the target receiver based on the LQI, and the LQI for the link from the target receiver to the target transmitter.

According to a further aspect of the present invention, there is provided a target receiver corresponding to a target transmitter, the target receiver including a reception unit to receive an LQI request message for requesting an LQI for a link from a target transmitter to a target receiver, an LQI measurement unit to measure the LQI based on the LQI request message, an LQI response message generator to generate an LQI response message including information about the LQI, and a transmission unit to transmit the generated LQI response message to the target transmitter, and the reception unit may receive data for the target receiver from the target transmitter, using a transmission frame of which length may be determined based on the LQI.

The target receiver may further include a decoding unit to acquire information about the length of the transmission frame by decoding a header of the transmission frame, and to acquire data for the target receiver by decoding a region including the data for the target receiver based on the acquired information about the length of the transmission frame.

The LQI response message generation unit may generate the LQI response message including a pilot signal that may be a basis for measuring of an LQI from the target receiver to the target transmitter by the target transmitter.

### EFFECT OF THE INVENTION

According to an embodiment of the present invention, a target transmitter may determine a length of a transmission frame based on a Link Quality Indicator (LQI), thereby overcoming an error by retransmitting a smaller size of packet when the error occurs. Accordingly, power consumption and data transmission delay due to the packet retransmission may be reduced, and a reliability of data transmission may increase.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a general wireless communication system;

FIG. 2 is a diagram illustrating a wireless communication system compliant with IEEE 802.15.4 standards;

FIG. 3 is a graph illustrating a relationship between a Signal Noise Ratio (SNR) and a Bit Error Ratio (BER) in a general wireless communication system;

FIG. 4 is a graph illustrating a Packet Error Ratio (PER) depending on a length of packet in a general wireless communication system;

FIG. 5 is a diagram illustrating a case in which all transmission frames include an N-byte payload (*according to a conventional art;

FIG. 6 is a diagram illustrating a case in which all transmission frames include an N/2-byte payload (*according to a conventional art;

FIG. 7 is a flowchart illustrating a method of determining a length of a transmission frame based on a Link Quality Indicator (LQI) according to an embodiment of the present invention;

FIG. 8 is a block diagram illustrating a target transmitter that determines a length of a transmission frame based on an LQI according to an embodiment of the present invention; and

FIG. 9 is a block diagram illustrating a target receiver communicating with a target transmitter that determines a length of a transmission frame based on an LQI according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined that a detailed description is related to a related known function or configuration which may make the purpose of the present invention unnecessarily ambiguous in the description of the present invention, such detailed description will be omitted. Also, terminologies used herein are defined to appropriately describe the exemplary embodiments of the present invention and thus may be changed depending on a user, the intent of an operator, or a custom. Accordingly, the terminologies must be defined based on the following overall description of this specification.

The present invention relates to a method and apparatus for changing a maximum length of a transmission frame based on a Link Quality Indicator (LQI) in order to improve a reliability of data transmission. Embodiments of the present invention may be applied to a local area wireless communication system compliant with IEEE 802.15.4 standards.

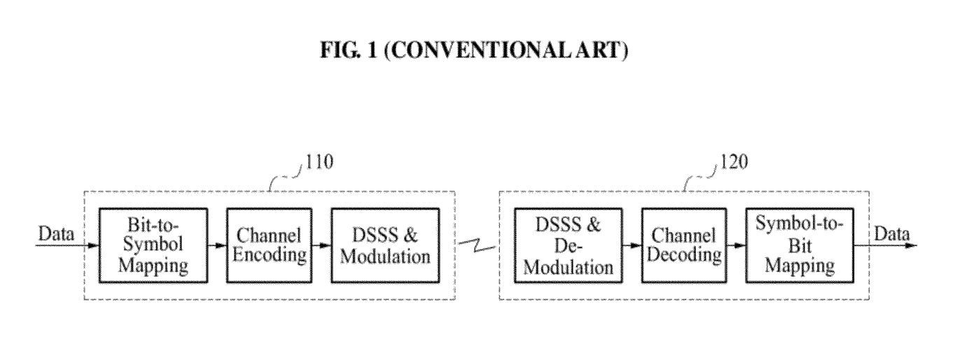

FIG. 1 is a diagram illustrating a conventional wireless communication system.

Referring to FIG. 1, a transmission end 110 transmitting data may convert the data into a symbol desired to be transmitted, using a Bit-to-Symbol Mapping block. The transmission end 110 may perform channel encoding in order to overcome an error occurring during a wireless transmission process. Also, the transmission end 110 may perform a modulation process, and may wirelessly transmit the data.

A reception end 120 may perform a demodulation process on the wireless signal transmitted from the transmission end 110, and may detect or rectify the error occurring during the wireless transmission process. The reception end 120 may finally acquire the data through a Symbol-to-Bit Mapping process.

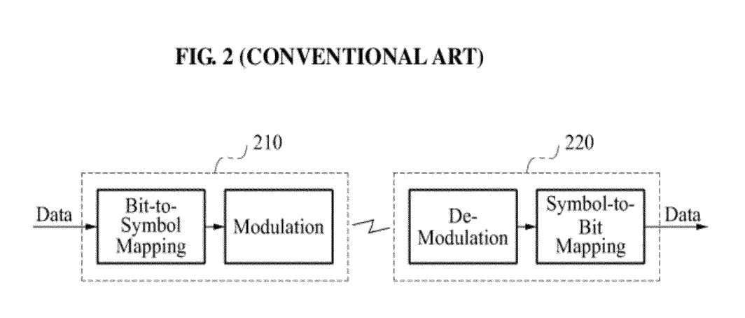

FIG. 2 is a diagram illustrating a wireless communication system compliant with IEEE 802.15.4 standards.

Referring to FIG. 2, a transmission end 210 and reception end 220 of IEEE 802.15.4 standards may not use a channel coding scheme in order to overcome an error occurring in a channel, for low power consumption, miniaturization, and a low cost of the wireless communication system. When an error occurs in a channel, the transmission end 210 of IEEE 802.15.4 standards may discard a packet, that is, a transmission frame in which an error occurs, and may retransmit a corresponding packet.

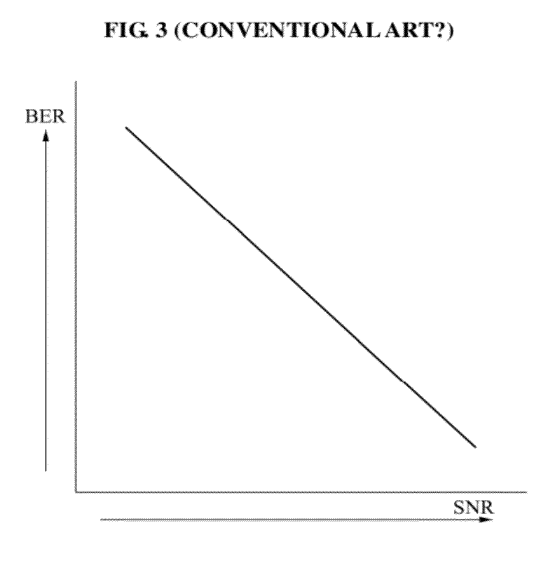

FIG. 3 is a diagram illustrating a relationship between a Signal Noise Ratio (SNR) and a Bit Error Ratio (BER) in a general wireless communication system.

Referring to FIG. 3, in the conventional wireless communication system, a low SNR may indicate a low probability of an error occurring during a data transmission process, and a high SNR may indicate a high probability of an error occurring during the data transmission process.

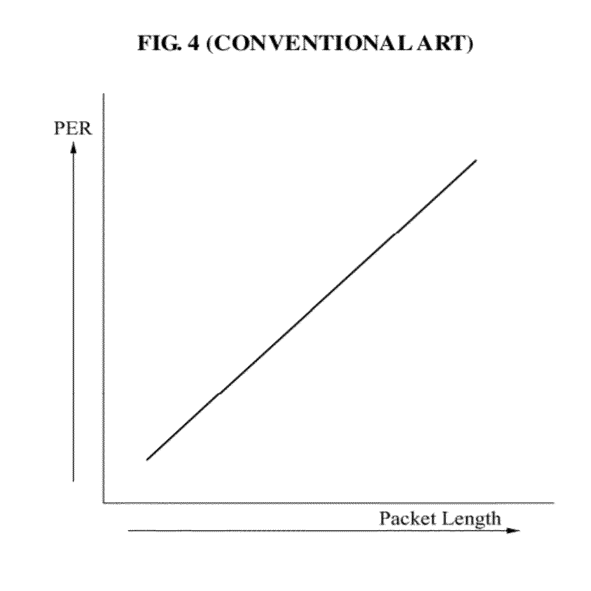

FIG. 4 is a diagram illustrating a Packet Error Ratio (PER) depending on a length of packet in a general wireless communication system.

Referring to FIG. 4, provided that it is assumed that a Bit Error Ratio (BER) is constant, the packet error ratio (PER) may increase when a length of a packet increases, that is, when a length of a transmission frame increases.

Accordingly, when the length of the transmission frame becomes longer, a probability of error occurring in the wirelessly transmitted packet may increase. In the wireless communication system compliant with IEEE 802.15.4 standards, when an SNR is low, the probability of error occurrence may increase more. Accordingly, transmission time delay and increase in energy consumption for transmission due to retransmission of the wirelessly transmitted packet may occur.

According to embodiments of the present invention, a probability that an error in a packet may occur during a wireless transmission process may be reduced, by determining a maximum size of packet to be wirelessly transmitted based on a state of a link between a transmitter and a receiver that may wirelessly exchange data.

According to embodiments of the present invention, in a case of retransmitting a packet due to an error occurring, energy consumption and packet transfer time may be reduced by retransmitting a packet of which a maximum size may be determined, that is, a packet of a small size.

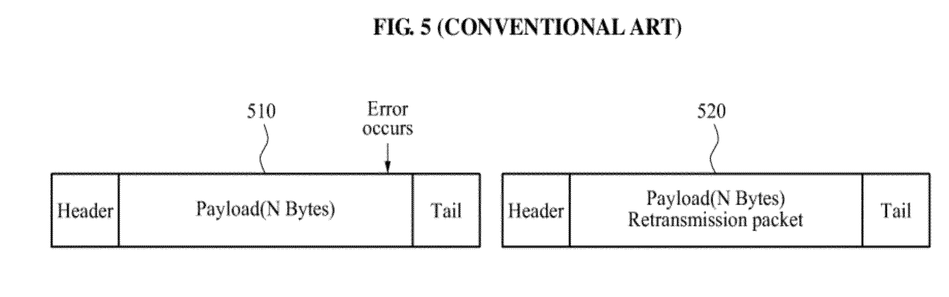

FIG. 5 is a diagram illustrating a case in which all transmission frames include an N-byte payload.

Referring to FIG. 5, in a case in which both a transmission frame 510 and a transmission frame 520 have an N-byte payload, when an error occurs in the transmission frame 510 that may be wirelessly transmitted, a transmitter may retransmit the transmission frame 520, having the N-byte payload. The transmission frame 520 may be a transmission frame identical to the transmission frame 510.

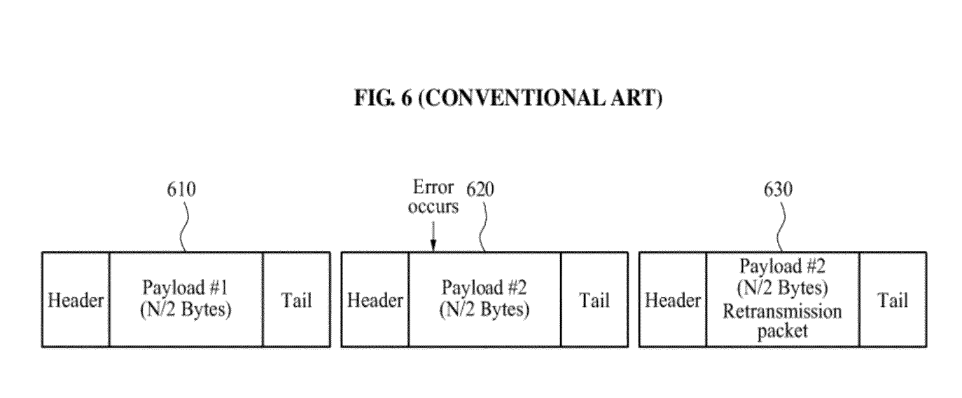

FIG. 6 is a diagram illustrating a case in which all transmission frames include an N/2-byte payload.

Referring to FIG. 6, in a case in which all transmission frames 610, 620, and 630 have an N/2-byte payload, when an error occurs in the transmission frame 620, a transmitter may retransmit the transmission frame 630, having the N/2-byte payload. The transmission frame 630 may be a transmission frame identical to the transmission frame 620.

In the case of FIG. 6 when compared to FIG. 5, a length of the transmission frame used for transmission when the error occurs may be shorter. Accordingly, an amount of time consumed for the retransmission and an amount of data to be retransmitted may be reduced when the length of the transmission frame is short.

A method of properly determining the length of the transmission frame based on an LQI will be further described hereinafter.

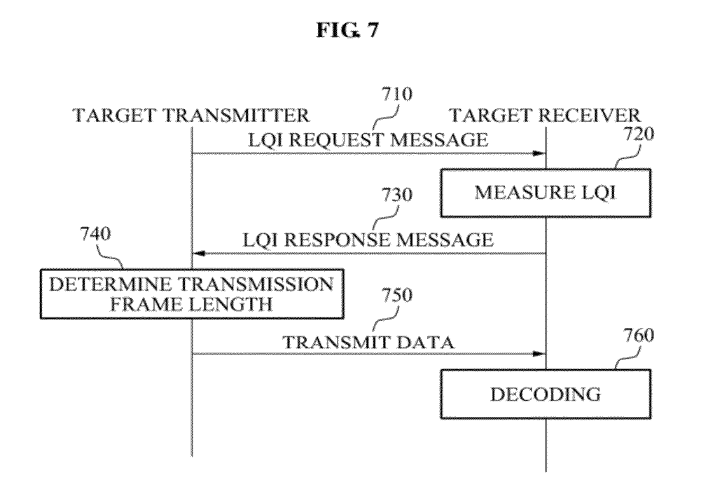

FIG. 7 is a flowchart illustrating a method of determining a length of a transmission frame based on an LQI according to an embodiment of the present invention.

Referring to FIG. 7, in operation 710, a target transmitter communicating with a target receiver may generate an LQI request message for requesting an LQI for a link from the target transmitter to the target receiver, and may transmit the generated LQI request message to the target receiver. Here, the target transmitter and target receiver may correspond to a transmitter and receiver of a local area wireless communication system compliant with IEEE 802.15.4 standards, respectively.

The LQI request message may include a pilot signal that may be a basis for measuring of the LQI by the target receiver.

In operation 720, the target receiver may receive the LQI request message, and may measure the LQI for the link from the target transmitter to the target receiver based on the received LQI request message.

In operation 730, the target receiver may transmit an LQI response message including the measured LQI. The LQI response message may include a pilot signal that may be a basis for measuring of an LQI for a link from the target receiver to the target transmitter by the target transmitter.

In operation 740, the target transmitter having received the LQI response message may determine a length of a transmission frame including data for the target receiver based on the LQI. The target transmitter may determine the length of the transmission frame proportional to the LQI.

The target transmitter may also measure the LQI for the link from the target receiver to the target transmitter, based on the LQI response message received from the target receiver. The target transmitter may determine the length of the transmission frame based on the LQI, and the LQI for the link from the receiver to the transmitter. Here, the both LQIs may be measured by the target receiver.

The target transmitter may generate a header of the transmission frame, including information about the length of the transmission frame.

In operation 750, the target transmitter may transmit data for the target receiver, using the transmission frame of which length may be determined.

The target receiver may receive the data for the target receiver, using the transmission frame of which length may be determined. In particular, in operation 760, the target receiver may acquire the information about the length of the transmission frame by decoding the header of the transmission frame, and may acquire the data for the target receiver by decoding a region including the data for the target receiver based on the information about the length of the transmission frame.

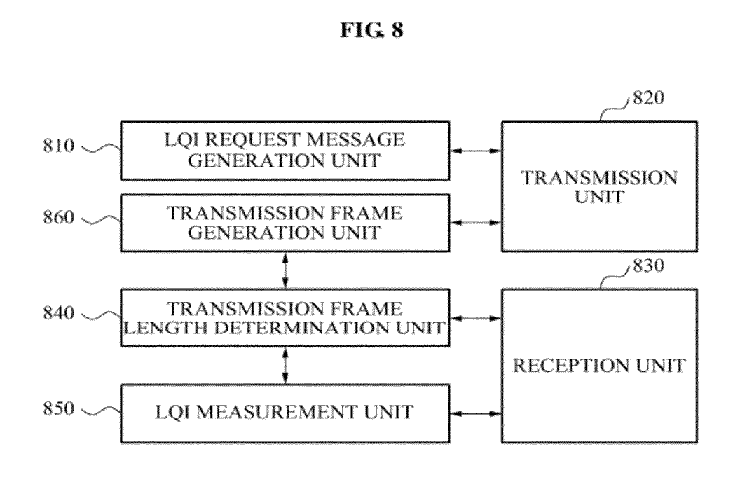

FIG. 8 is a block diagram illustrating a target transmitter that determines a length of a transmission frame based on an LQI according to an embodiment of the present invention.

Referring to FIG. 8, the target transmitter may include an LQI request message generation unit 810, a transmission unit 820, a reception unit 830, a transmission frame length determination unit 840, an LQI measurement unit 850, and a transmission frame generation unit 860.

The target transmitter may correspond to a transmitter of a local area wireless communication system compliant with IEEE 802.15.4 standards.

The LQI request message generation unit 810 may generate an LQI request message for requesting an LQI for a link from the target transmitter to a target receiver. That is, the LQI request message generation unit 810 may generate the LQI request message including a pilot signal that may be a basis for measuring of the LQI by the target receiver.

The transmission unit 820 may transmit the LQI request message to the target receiver. Also, the transmission unit 820 may transmit data for the target receiver using a transmission frame of which length may be determined by the transmission frame length determination unit 840.

The reception unit 830 may receive, from the target receiver, an LQI response message including information about the LQI.

The transmission frame length determination unit 840 may determine the length of the transmission frame including the data for the target receiver, proportional to the LQI. The transmission frame length determination unit 840 may determine the length of the transmission frame including the data for the target receiver, based on the LQI measured by the target receiver, and an LQI for a link from the target receiver to the target transmitter, that may be measured by the LQI measurement unit 850.

The LQI measurement unit 850 may measure the LQI for the link from the target receiver to the target transmitter, based on the LQI response message received from the target receiver.

The transmission frame generation unit 860 may generate a header of the transmission frame including the information about the length of the transmission frame.

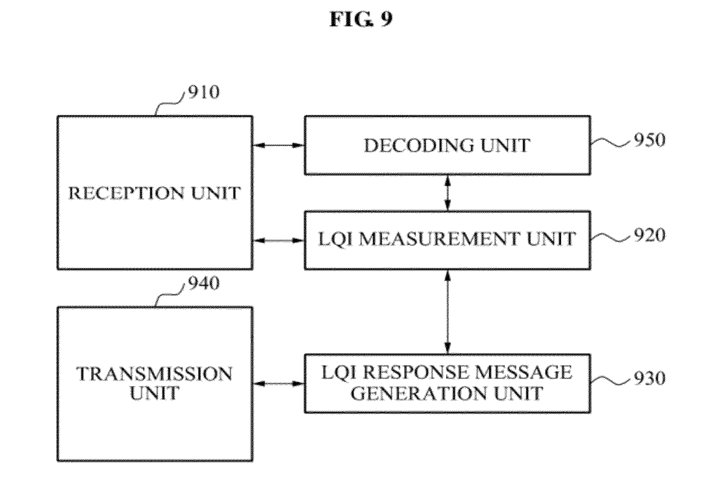

FIG. 9 is a block diagram illustrating a target receiver communicating with a target transmitter that determines a length of a transmission frame based on an LQI according to an embodiment of the present invention.

Referring to FIG. 9, the target transmitter may include a reception unit 910, an LQI measurement unit 920, an LQI response message generation unit 930, a transmission unit 940, and a decoding unit 950.

The target receiver may correspond to a receiver of a local area wireless communication system compliant with IEEE 802.15.4 standards.

The reception unit 910 may receive an LQI request message for requesting an LQI for a link from the target transmitter to the target receiver. Also, the reception unit 910 may receive data for the target receiver from the target transmitter, using a transmission frame of which length is determined based on the LQI.

The LQI measurement unit 920 may measure the LQI for the link from the target transmitter to the target receiver, based on the LQI request message.

The LQI response message generation unit 930 may generate an LQI response message including information about the LQI. The LQI response message generation unit 930 may generate the LQI response message including a pilot signal that may be a basis for measuring of an LQI a link from the target receiver to the target transmitter by the target transmitter.

The transmission unit 940 may transmit the LQI response message to the target transmitter.

The decoding unit 950 may acquire the information about the length of the transmission frame by decoding a header of the transmission frame, and may acquire data for the target receiver by decoding a region including the data for the target receiver based on the information about the length of the transmission frame.

A target transmitter and target receiver according to embodiments of the present invention have been described. The same aforementioned description provided using various embodiments in relation to FIGS. 1 through 7 is applicable to the target transmitter and target receiver, and accordingly a further description will be omitted for conciseness.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A communication method of a target transmitter, the method comprising:
transmitting, to a target transmitter, a Link Quality Indicator (LQI) request message for requesting an LQI for a link from the target transmitter to a target receiver;
receiving, from the target receiver, an LQI response message including information about the LQI;
determining a length of a transmission frame including data for the target receiver, based on the LQI; and
transmitting the data for the target receiver using the transmission frame of which length is determined.

2. The method of claim 1, wherein the determining comprises determining the length of the transmission frame proportional to the LQI.

3. The method of claim 1, further comprising:
generating a header of the transmission frame, including information about the length of the transmission frame.

4. The method of claim 1, wherein the target transmitter corresponds to a transmitter of a local area wireless communication system compliant with IEEE 802.15.4 standards.

5. The method of claim 1, wherein the LQI request message comprises a pilot signal that is a basis for measuring of the LQI by the target receiver.

6. The method of claim 1, further comprising:
measuring an LQI for a link from the target receiver to the target transmitter, based on the LQI response message received from the target receiver,
wherein the determining comprises determining the length of the transmission frame including the data for the target receiver based on the LQI, and the LQI for the link from the target receiver to the target transmitter.

7. A communication method of a target receiver corresponding to a target transmitter, the method comprising:
receiving a Link Quality Indicator (LQI) request message for requesting an LQI for a link from a target transmitter to a target receiver;
measuring the LQI based on the LQI request message;
transmitting, to the target transmitter, an LQI response message including information about the LQI; and
receiving data for the target receiver from the target transmitter, using a transmission frame of which length is determined based on the LQI.

8. The method of claim 7, wherein the receiving comprises:
acquiring information about the length of the transmission frame by decoding a header of the transmission frame; and
acquiring data for the target receiver by decoding a region including the data for the target receiver based on the acquired information about the length of the transmission frame.

9. The method of claim 7, wherein the target receiver corresponds to a receiver of a local area wireless communication system compliant with IEEE 802.15.4 standards.

10. The method of claim 7, wherein the LQI response message comprises a pilot signal that is a basis for measuring of an LQI a link from the target receiver to the target transmitter by the target transmitter.

11. A target transmitter, comprising:
a Link Quality Indicator (LQI) request message generation unit to generate an LQI request message for requesting an LQI for a link from a target transmitter to a target receiver;
a transmission unit to transmit the generated LQI request message to the target receiver;
a reception unit to receive an LQI response message including information about the LQI, from the target receiver; and
a transmission frame length determination unit to determine a length of a transmission frame including data for the target receiver, proportional to the LQI,
wherein the transmission unit transmits the data for the target receiver using the transmission frame of which length is determined.

12. The target transmitter of claim 11, further comprising:
a transmission frame generation unit to generate a header of the transmission frame including information about the length of the transmission frame.

13. The target transmitter of claim 11, wherein the target transmitter corresponds to a transmitter of a local area wireless communication system compliant with IEEE 802.15.4 standards.

14. The target transmitter of claim 11, wherein the LQI request message generation unit generates the LQI request message including a pilot signal that is a basis for measuring of the LQI by the target receiver.

15. The target transmitter of claim 11, further comprising:
an LQI measurement unit to measure an LQI for a link from the target receiver to the target transmitter, based on the LQI response message received from the target receiver,
wherein the transmission frame length determination unit determines the length of the transmission frame including the data for the target receiver based on the LQI, and the LQI for the link from the target receiver to the target transmitter.

16. A target receiver corresponding to a target transmitter, the target receiver comprising:
a reception unit to receive a Link Quality Indicator (LQI) request message for requesting an LQI for a link from a target transmitter to a target receiver;
an LQI measurement unit to measure the LQI based on the LQI request message;
an LQI response message generator to generate an LQI response message including information about the LQI; and
a transmission unit to transmit the generated LQI response message to the target transmitter,
wherein the reception unit receives data for the target receiver from the target transmitter, using a transmission frame of which length is determined based on the LQI.

17. The target receiver of claim 16, further comprising:
a decoding unit to acquire information about the length of the transmission frame by decoding a header of the transmission frame, and to acquire data for the target receiver by decoding a region including the data for the target receiver based on the acquired information about the length of the transmission frame.

18. The target receiver of claim 16, wherein the LQI response message generation unit generates the LQI response message including a pilot signal that is a basis for measuring of an LQI a link from the target receiver to the target transmitter by the target transmitter.
